(19) United States
(12) Patent Application Publication
(10) Pub. No.: US 2026/0223023 A1
(43) Pub. Date: Jul. 30, 2026

(54) TIMING SYNCHRONIZATION STATUS REPORTING COMPLIANT WITH UE'S SUBSCRIPTION

(71) Applicant: Telefonaktiebolaget LM Ericsson (publ), Stockholm (SE)

(72) Inventors: Aleksejs UDALCOVS, Stockholm (SE); Marilet DE ANDRADE JARDIM, Stockholm (SE); Shabnam SULTANA, Montréal (CA)

(73) Assignee: Telefonaktiebolaget LM Ericsson (publ), Stockholm (SE)

(21) Appl. No.: 19/143,900

(22) PCT Filed: Dec. 21, 2023
(86) PCT No.: PCT/IB2023/063142

§ 371 Date: Jun. 27, 2025

Related U.S. Application Data
(60) Provisional application No. 63/437,825, filed on Jan. 9, 2023.

(51) Int. Cl. H04W 56/00; H04J 3/06; H04W 8/20

(52) U.S. Cl. CPC H04W 56/0015; H04J 3/0658; H04W 8/20

(57) ABSTRACT

A method and apparatus are provided wherein the method is performed by a first network function in a communication system, where the first network function may be an Access and Mobility Management function in a 5G system or a Time Sensitive Communication and Time Synchronization Function (TSCTSF). The first network function receives a message from a second network function comprising requested Clock Quality Reporting Control Information (CQRCI) for at least one UE and in response to determining the CQRCI is not compliant to obtained UE subscribed CQRCI for the at least one UE, the first network function overrides the CQRCI with the UE subscribed CQRCI and sends the UE subscribed CQRCI directly or indirectly to a third network function serving the UE, for example a NG-RAN node if the first network function is an AMF or an AMF if the first network function is the TSCTSF.

### RELATED APPLICATIONS

This application claims the benefit of provisional patent application Ser. No. 63/437,825, filed on Jan. 9, 2023 the disclosures of which are hereby incorporated herein by reference in their entirety.

### TECHNICAL FIELD

The present disclosure relates to a wireless communication system and, more specifically, a wireless communication system communicating with a Time Sensitive communication network.

### BACKGROUND

In a 5G wireless network of FIG. 2, there can be various network functions, including, but not limited to:
SMF (Session Management Function), that is responsible for Session establishment, modification and release, including selection and control of the UPF entities, maintaining the topology of the involved PSA UPFs, establishing and releasing the tunnel between AN and UPF and between UPFs. It also configures traffic forwarding at UPF. The SMF interacts with the UPF over N4 Reference point using PFCP procedures.
AMF (Access and Mobility Management Function), that is responsible for a number of functions comprising but not limited to termination of RAN Control Plane interface (N2), termination of NAS (N1), NAS ciphering and integrity protection, Registration management, Connection management, Reachability management, Mobility Management, Access Authentication and Authorization, UE mobility event notification.
UPF (User Plane Function), that handles the user data traffic. Among other, it provides the external PDU Session point of interconnect to Data Network (PDU session anchor, PSA) and performs packet routing & forwarding (e.g. support of Uplink classifier (UL CL) to route traffic flows to an instance of a data network, support of Branching point to support multi-homed PDU Session).
PCF (Policy Control Function), supports a unified policy framework to govern the network behavior. Specifically, for this invention, the PCF provides PCC (Policy and Charging Control) rules to the PCEF (Policy and Charging Enforcement Function), i.e. the SMF/UPF that enforces policy and charging decisions according to provisioned PCC rules.
NEF (Network Exposure Function), supports different functionality and specifically in the context of this IvD, NEF acts as the entry point into operator's network, so an external AF (Content Provider) interacts with the 3GPP Core Network through NEF.
AF (Application Function), may send requests to influence SMF routing decisions for traffic of PDU Session. The AF requests may influence UPF (re)selection and allow routing user traffic to a local access to a Data Network (identified by a DNAI). The AF may communicate directly with PCF in the SBA domain or indirectly through the NEF, i.e., having an API to the NEF that conveys the AF communication to the PCF.
UDM (Unified Data Management): is a front-end for the user subscription data stored in the UDR. The UDM uses subscription data that may be stored in UDR to execute application logic like access authorization, registration management and reachability for terminating event e.g., SMS.
TSCTSF (Time Sensitive Communication and Time Synchronization Function): supports amongst other functionalities associating the time synchronization service request from the NF consumer to the AF sessions with the PCF (the session between the PCF and TSCTSF).

In 3GPP TR 23.700-25, the “Study on timing resiliency and TSC and URLLC enhancements (Release 18)”, it has been agreed that a User Equipment (UE) with the corresponding subscription may get informed about the timing synchronization status change. This is described as Key issue #1, for which a number of solutions have been suggested including solutions 1, 3, 4, 5, 14 and 17 described in the TR 23.700-25 available by the priority date of this application. However, the level of information may differ depending on the UE's subscription as summarized in clause 8.5 of the TR 23.700-25, hereby reproduced with some emphasis added:

“If a UE is subscribed for Access Stratum Time Synchronization (ASTI) in the UDM (see clause 8.6 of the same TR), then the “Access and Mobility Subscription data” may additionally contain the following clock quality reporting control information:
Clock quality detail level: indicates whether and which clock quality information to provide to the UE and can take one of the following values: clock quality metrics or acceptable/not acceptable indication; and/or
Clock quality acceptance criteria for the UE (if the clock quality level equals “acceptable/not acceptable indication”: the clock quality acceptance criteria for the UE (e.g. acceptable clock accuracy, acceptable frequency stability, etc.).”

Hence, the “Clock Quality Reporting Control Information” determines whether a UE is eligible to get the detailed information about clock quality metrics characterizing the current state of a time synchronization status or just an indication on whether the time synchronization status is “Acceptable/Not Acceptable”.

Then, it has been also agreed that if an AF 212 request Access Stratum Time Synchronization (ASTI) service, then the AF 212 may also include “Clock Quality Reporting Control Information” when creating or modifying a service request. This is stated as follows in the same clause 8.5 of the TR:
“—If an AF 212 requests Access Stratum Time Synchronization (ASTI) for a UE, then the AF 212 may provide clock quality reporting control information to TSCTSF. TSCTSF provides the clock quality reporting control information to AMF.
   When AMF 200 provides the 5G access stratum time distribution indication and the Uu time synchronization error budget to NG-RAN, AMF 200 also includes the clock quality reporting control information.
   Based on the clock quality reporting control information received from AMF, RAN reports its timing synchronization status to the UE using unicast RRC:
      If clock quality detail level is set to “clock quality metrics”, then the RAN provides clock quality metrics to the UE that reflect its current timing synchronization status. Clock quality metrics refers to information such as clock accuracy, traceability to UTC, frequency stability, etc.
      If clock quality detail level is set to “acceptable/not acceptable indication”, then the RAN provides an acceptable indication to the UE if the RAN's timing synchronization status matches the acceptance criteria received from AMF; otherwise RAN indicates “not acceptable” to the UE.”

Referring to “Procedures for management of 5G access stratum time distribution” in clause 4.15.9.4 of 3GPP TS 23.502, the TSCTSF invokes Nudm_SDM_Get request with UDM to retrieve UE's subscription data (as specified in clause 5.2.3.3.1 of TS 23.502). At this step, the TSCTSF performs the subscription check and ensures that a UE, for whom the AF 212 requests the ASTI service, has the corresponding subscription. Clause 5.27.1.11 of 3GPP TS 23.501, specifies “Controlling time synchronization service based on the Subscription”:
“The distribution of timing information, 5G access stratum-based time distribution and (g)PTP-based time distribution, for a UE may be controlled based on subscription data stored in the UDM. The (g)PTP-based or 5G access stratum-based time synchronization service may be provided to a UE based on the UE's subscription which is specified in the TS 23.502 clause 5.2.3.3.1.
The Access and Mobility Subscription data include for the control of 5G access stratum-based time distribution the following information:
   the Access Stratum Time Synchronization Service Authorization, which indicates whether the UE should be provisioned with 5G system internal clock timing information over access stratum as specified in 3GPP TS 38.331.
   optionally, the Uu time synchronization error budget.
   optionally, one or more periods of start and stop times defining the times when the UE should be provisioned with 5G system internal clock timing information.
   optionally, a Time Synchronization Coverage Area comprising a list of TAs where the UE shall be provisioned with 5G system internal clock timing information.
During the Registration procedure, the AMF 200 retrieves the subscription from UDM. If the AMF 200 receives 5G access stratum-based time synchronization service subscription for the given UE, the AMF 200 controls the 5G access stratum-based time distribution:”

Based on the specifications above, both the AMF 200 and the TSCTSF retrieve UE's subscription data from the UDM via Nudm_SDM_Get request; and Clock Quality Reporting Control Information may be included as a part of Access and Mobility Subscription data. At the same time, an AF 212 within/outside the operator's trust domain may include “Clock Quality Reporting Control Information” in its request for ASTI service (Nnef/tsctsf_ASTI_Create/Update).

### SUMMARY

There currently exist certain challenge(s). As indicated above, the AF(s) may include “Clock Quality Reporting Control Information” requesting that “Clock Quality Metrics” are reported to a UE instead of “Acceptable/Not Acceptable” indication as allowed by the subscription. According to the current study, the UE may therefore get more detailed level of information than it has the subscription for. Furthermore, an AF 212 could also request more tight/loose parameters when specifying “Clock Quality Acceptance Criteria” for “Acceptable/Not Acceptable” indication, which also would lead to the misalignment with the subscription and open possibilities for other malicious misuse. This aspect is not addressed in the current 3GPP TR.

Certain aspects of the present disclosure and their embodiments may provide solutions to the aforementioned or other challenges.

This present disclosure proposes a solution for a Core Network function (i.e., TSCTSF or AMF) to perform a compliance check for Clock Quality Reporting Control Information before proceeding with the AF 212 requested ASTI service activation/modification (update). This compliance check procedure is required in cases when the AF 212 includes “Clock Quality Reporting Control Information” in its request, and the 5G network/system needs to ensure that the request complies with UE's subscription (for whom the service is being requested/modified). The compliance check proposed herein is not performed within the existing solutions in the 3GPP standard. The compliance check can be summarized as comparing “Clock Quality Reporting Control Information” in for example the Access and Mobility Subscription data retrieved from UDM 308 and “Clock Quality Reporting Control Information” requested by an AF. If the request does not comply with the UE's subscription, either one of the following options can be performed:
Option 1: an Nnef/tsctsf_ASTI_Create/Update request is rejected (in cases when the TSCTSF is the NF that make the compliance check); Note that the AMF 200 may also reject the request if the TSCTSF does not perform the performance check.
Option 2: AF 212 requested “Clock Quality Reporting Control Information” is overridden by the UE's subscription; for that, the compliance check may be performed either by the TSCTSF 205 or by the AMF 200.

In accordance with some embodiments, a method performed by for example a TSCTSF or an AMF 200 in a 5G System used as an example of a system is provided. Note that any other comparable system 6G or beyond can be used as long as they include functionally comparable functions.

The method comprises the step of receiving a message from a second network function comprising requested Clock Quality Reporting Control Information (CQRCI) for at least one UE. The second network function may be a NEF 215 or AF 212 if the method is performed by a TSCTSF 205 or the second network function may be a PCF 210 if the first network function is an AMF. The AMF 200 and PCF 210 having an established Access & Mobility (AM) policy association, in which case the message is for example a modification request to the established AM policy. The method further comprises, in response to determining by the TSCTSF or AMF 200 the CQRCI is not compliant to obtained UE subscribed CQRCI for the at least one UE (e.g., one UE or a group of UE), overriding the CQRCI with the UE subscribed CQRCI and sending the UE subscribed CQRCI directly or indirectly to a third network function serving the UE or sending a rejection message to the second network function. The UE subscribed CQRCI may be obtained from a subscription data management function such as UDM 308 and the third network function may the AMF 200 if the method is performed by the TSCTSF in which case the TSCTSF sends the information indirectly to the AMF 200 via the PCF. The third network function may be a NG-RAN node if the method is performed by the AMF.

In another aspect, the method further comprises the step of in response to determining the received CQRCI is compliant to the obtained UE subscribed CQRCI, sending the received CQRCI for the at least one UE directly or indirectly to the third network function serving the UE.

In one example, the received Clock Quality Reporting Control Information or the UE subscribed CQRCI correspond to Clock Quality Detail Level and Clock Quality Acceptance Criteria or a Clock Quality Acceptance Criteria.

A network node or server is provided and which is adapted to perform the method of any one of the embodiments describe herein.

In another example, a network node or server is provided and comprising one or more processors and memory comprising instructions which when executed by the one or more processors perform any one of the embodiments describe herein.

In another example, a non-transitory computer-readable storage medium is provided that includes executable instructions that when executed by a processor cause the processor to perform the method any one of the embodiments describe herein.

### BRIEF DESCRIPTION OF THE DRAWINGS

The accompanying drawing figures incorporated in and forming a part of this specification illustrate several aspects of the present disclosure, and together with the description serve to explain the principles of the present disclosure.

FIG. 1 illustrates one example of a wireless communications system in which embodiments of the present disclosure may be implemented;

FIG. 2 illustrates one example of a core network of a wireless communications system supporting time synchronization in which embodiments of the present disclosure may be implemented;

FIG. 3 illustrates another example of a core network of a wireless communications system illustrating 5G System (5GS) in a service based architecture supporting time synchronization;

FIG. 4A illustrates a procedure for Management of 5G access stratum time information according to some embodiments;

FIG. 4B illustrates a procedure for Management of 5G access stratum time information according to other embodiments;

FIG. 5; illustrates a flow chart for a method performed at TSCTSF according to some embodiments.

FIG. 6 illustrates a flow chart for a method performed at the Access Mobility management function according to some embodiments.

FIGS. 7, 8, and 9 are schematic block diagrams of example embodiments of a network node or server.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Although the embodiments are described using a 5G core network, it will be apparent to a person skilled in the art that any core network that supports edge computing can implement these embodiments, including 4G, 6G and beyond.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node or server in a core network or any node or server that implements a core network function. Some examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF 215), a Network Function (NF) Repository Function (NRF), a Policy Control Function (PCF), a Unified Data Management (UDM 308), a TSCTSF 205 and an AF 212 or the like. One or more network functions may be implemented or hosted on the same node/server or may be distributed across multiple nodes/servers.

Communication Device: As used herein, a “communication device” is any type of device that has access to an access network. Some examples of a communication device include, but are not limited to: a mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

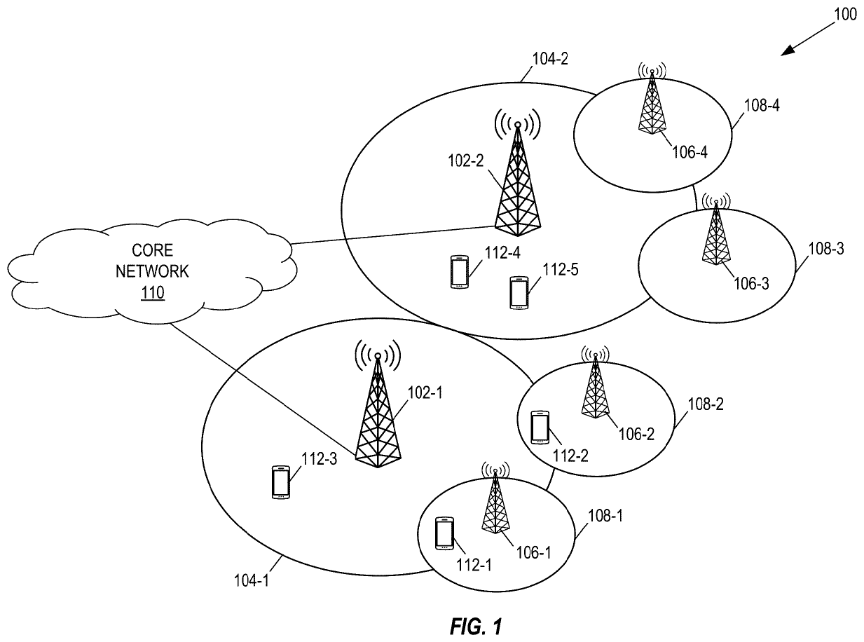

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC). In this example, the RAN includes base stations 102-1 and 102-2, which in the 5GS include NR base stations (gNBs), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

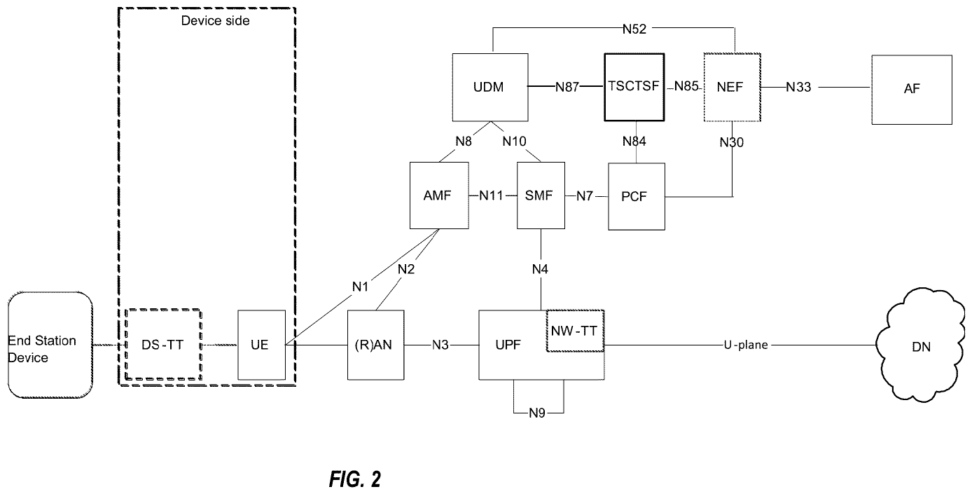

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the cellular communications system 100 of FIG. 1.

A Network Function (NF) may be implemented either as a network element on a dedicated hardware, as a software instance running on a dedicated hardware, or as a virtualized function instantiated on an appropriate platform, e.g., a cloud infrastructure.

Seen from the access side the 5G network architecture shown in FIG. 2 comprises a plurality of UEs 112 connected to either a RAN 102 or an Access Network (AN) as well as an AMF 200. Typically, the R(AN) 102 comprises base stations, e.g., such as eNBs or gNBs or similar. Seen from the core network side, the 5GC NFs shown in FIG. 2 include a NSSF 202, an AUSF 204, a UDM 308, the AMF 200, a SMF 208, a PCF 210, an Application Function (AF) 212, a NEF 215 and a TSCTSF 205.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208. FIG. 2 further illustrates a 5G architecture that supports Time Sensitive Communication and Time Synchronization services based on IEEE Std 802.1AS or IEEE Std 1588 for Ethernet or IP type PDU Sessions. The DS-TT, NW-TT and Time Sensitive Communication and Time Synchronization Function (TSCTSF) are required in order to support the features in IEEE Std 802.1AS or IEEE Std 1588. The NEF 215 exposes 5GS capability to support Time Synchronization service as described in clause 5.27.1.8 of 3GPP TS 23.501. TSCTSF controls the DS-TT(s) and NW-TT for the (g)PTP based time synchronization service. In addition, TSCTSF supports TSC assistance container related functionalities. If the AF 212 is considered to be trusted by the operator, the AF 212 could interact directly with TSCTSF over N85 reference point, else it interacts with the TSCTSF via the NEF 215 over the N33 reference point. The connection between AF 212 and TSCTSF is not depicted in the architecture diagram of FIG. 2 for brevity.

The 5GC network aims at separating UP and CP. The UP carries user traffic while the CP carries signaling in the network. In FIG. 2, the UPF 214 is in the UP and all other NFs, i.e., the AMF 200, SMF 208, Policy Control Function (PCF) 210, AF 212, Network Slice Selection Function (NSSF) 202, Authentication Server Function (AUSF) 204, and UDM 308, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency. The UPF/NW-TT of FIG. 2 distributes the (g)PTP messages towards the DS-TTs. When the UPF supports one or more NW-TT(s), there is one-to-one association between an NW-TT and the network instance or between an NW-TT and network instance together with DNN/S-NSSAI in the UPF. When there are multiple network instances within a UPF, each network instance is considered logically separate. The network instance for the N6 interface may be indicated by the SMF to the UPF for a given PDU Session during PDU Session establishment procedure. The UPF allocates resources based on the Network Instance and S-NSSAI. The DNN/S-NSSAI may be indicated by the SMF together with the network instance to the UPF for a given PDU Session during PDU Session establishment procedure.

The same NW-TT is used for all PDU Sessions in the UPF for the given DNN/S-NSSAI; the NW-TT is unique per DNN/S-NSSAI. This ensures that the UPF selects an N4 session associated with the correct TSCTSF when the NW-TT initiates a user plane node Management Information Container (UMIC) or a Port Management Information Container (PMIC). Port management information is transferred transparently via 5GS between TSN AF or TSCTSF 205 and DS-TT or NW-TT, respectively, inside PMIC. User plane node management information is transferred transparently via 5GS between TSN AF or TSCTSF and NW-TT inside a UMIC. At any given time, the NW-TT is associated with a single TSCTSF.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

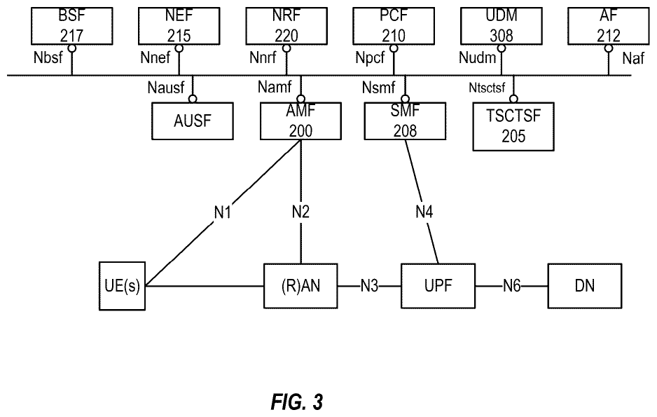

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. However, it should be clarified that all NFs depicted in FIG. 2 can interact with the NEF 215 and the NRF of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE even using multiple access technologies is basically connected to a single AMF 200 because the AMF 200 is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF operate properly. The AUSF supports authentication function for UEs or similar and thus stores data for authentication of UEs or similar while the UDM 308 stores subscription data of the UE. The Data Network (DN), not part of the 5GC network, provides Internet access or operator services and similar. Add something on TSCTSF 205 and AF 212 and NEF 215. The TSCTSF 205 offers a number of services via the Ntsctsf API, mainly Ntsctsf_TimeSynchronization providing time synchronization service based on (g)PTP or 5G access stratum time distribution method, and allows the NF consumer to subscribe for the UE and 5G Core (5GC) capabilities for (g)PTP or 5G access stratum based time synchronization service, as well as allows the NF consumer to configure the UEs and the 5GC for the (g)PTP based time synchronization service. TSCTSF 205 also supports Ntsctsf_ASTI service that provides support for time synchronization service based on 5G access stratum time distribution method as described in clause 5.27.1.8 of 3GPP TS 23.501 V. 17.6.0 (included herein by reference) and allows the NF consumer to configure the 5G Core and RAN for 5G access stratum based time synchronization service for the UEs. An AF 212 can access the services directly through the Ntsctsf API or via the NEF 215 using the Nnef API.

An NF may be implemented either as a network element on a dedicated hardware, as a software instance running on a dedicated hardware, or as a virtualized function instantiated on an appropriate platform, e.g., a cloud infrastructure.

Now, the description turns to some particular embodiments of the present disclosure.

In order to obtain information about 5G System (5GS) network timing synchronization status, TSCTSF 205 subscribes to NG-RAN and/or UPF (if the UPF/NW-TT is involved in providing timing information to a UE/DS-TT and only for (g)PTP time distribution method) timing synchronization status information, when the feature is active. When configured, both the NG-RAN and the UPF can detect timing synchronization degradations/failures/improvements locally. In the case of UPF timing synchronization status, the detection is based on the information provided by transport network time synchronization protocols and, in case of the NG-RAN timing synchronization status, the detection is based on the information from a local GNSS receiver.

The TSCTSF 205 retrieved information from a NG-RAN/UPF is at a node-level; and it can contain, synchronization state (“Locked”, “Holdover”, “Freerun”) [optional], source type (e.g, “PTP”, “GNSS”, “other”) [optional], clock quality descriptor (e.g., “clockClass”, “ClockAccuracy”, “gnss-rx-time-error”) [mandatory]. Once the information about the NG-RAN and/or the UPF timing synchronization status is obtained, the TSCTSF 205 determines whether any UE with an ongoing time synchronization service is impacted by a timing synchronization degradation/failure/improvement event.
To determine UEs impacted by a NG-RAN timing synchronization degradation/failure/improvement, the TSCTSF 205 correlates the information about NG-RAN nodes impacted by a timing synchronization status changes and UE's Presence in Area of Interest for UEs for which AF 212 has requested a time synchronization service or for which a (g)PTP-based time synchronization service has been activated based on the subscription. When subscribing to UE's Presence in Area of Interest from an AMF serving the UE(s), the TSCTSF 205 specifies the Area of Interest by a list of RAN node IDs that have the same NG-RAN timing synchronization status.
To determine UEs impacted by a UPF timing synchronization degradation/failure/improvement (only for cases where a UPF/NW-TT is involved in providing timing information to a DS-TT), the TSCTSF 205 identifies UEs for which the impacted UPF/NW-TT is configured to send (g)PTP messages.

If an AF 212 is a requester of a (g)PTP or ASTI-based time synchronization service, the AF 212 may subscribe to the TSCTSF 205 to get informed about the timing synchronization status change for those UEs or a group of UEs with the corresponding subscription for time synchronization services and impacted by NG-RAN or UPF timing synchronization degradations/failures/improvements. Together with a notification about a timing synchronization status, the TSCTSF 205 may indicate to the AF 212 whether the ongoing (g)PTP or ASTI-based time synchronization service can/cannot be supported as per the requested criteria (e.g., a time synchronization error budget) and may inquire the AF 212 about intentions to deactivate the service.

UEs with the corresponding subscription also may get informed about the timing synchronization status change. However, to ensure the backward compatibility with Rel-17 UEs, time synchronization status report can be sent to a UE only when the UE has a corresponding subscription, and the subscription data contains “Clock Quality Reporting Control Information”.

The level of information about an NG-RAN timing synchronization degradations/failures/improvements reported to a UE is set by Clock Quality Reporting Control Information that includes:
Clock Quality Detail Level: it indicates whether and which clock quality information shall be provided to the UE, and it can be set to “Clock Quality Metrics” or to “Acceptable/Not Acceptable” indication; and/or
Clock Quality Acceptance Criteria: it shall be specified if the Clock Quality Detail Level for the UE is set to “Acceptable/Not Acceptable” indication and then parameters constituting the clock quality acceptance criteria for the UE shall be provided. These parameters can be, for example, acceptable synchronization state, acceptable clock quality descriptor, etc.

Note that whether and which clock quality information to provide to the UE depends on the needs of the time service consumer (referred to as client network operator hereafter). Therefore, the clock quality detail level and/or clock quality acceptance criteria are based on the parameters and their values specified in the agreement between the 5G network operator and the client network operator. The clock quality acceptance criteria consider propagation delays while UE capabilities and internal inaccuracies are assumed to be budgeted by the client network operator when agreeing the required clock accuracy with the 5G network operator.

The Clock Quality Reporting Control Information may be a part of “Access and Mobility Subscription data” stored in a UDM 308 to specify a UE's subscription for Access Stratum Time Synchronization (ASTI) services.

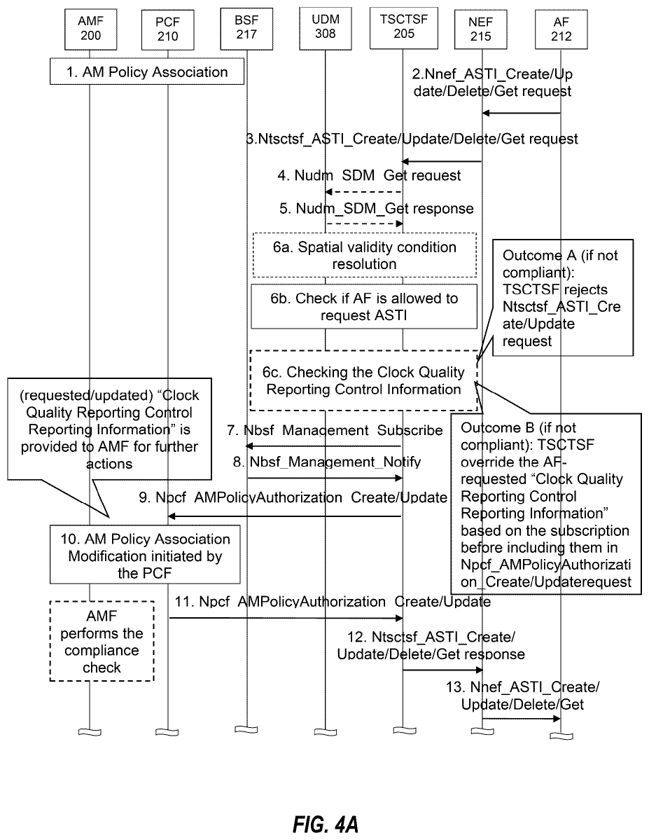

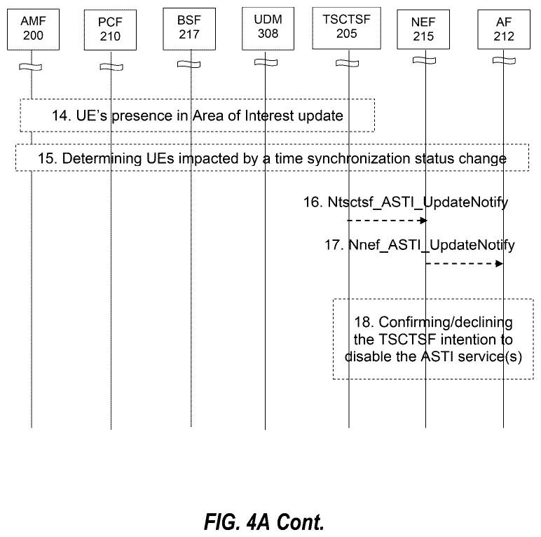

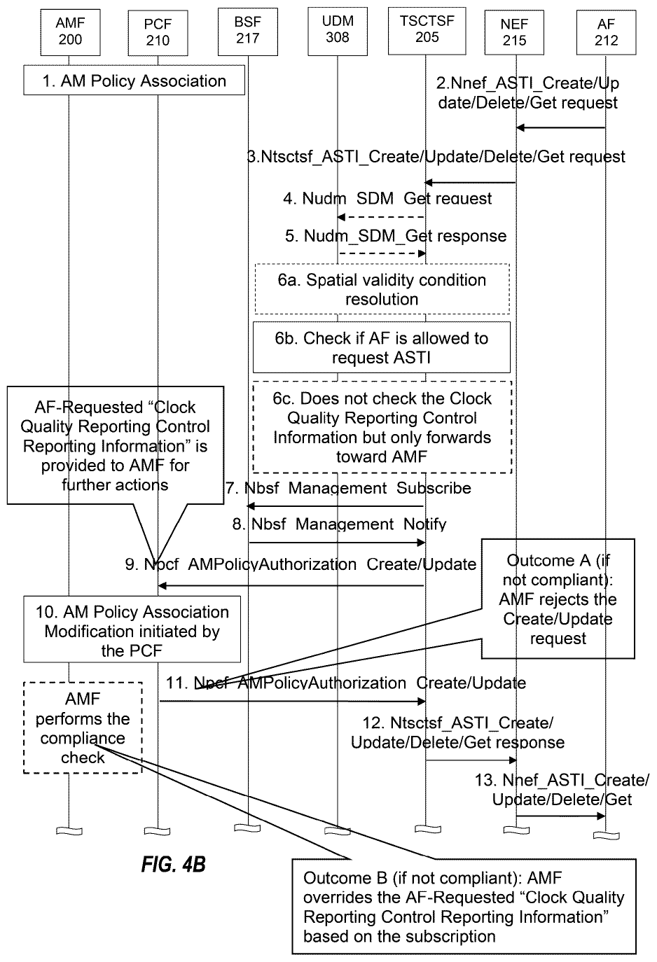

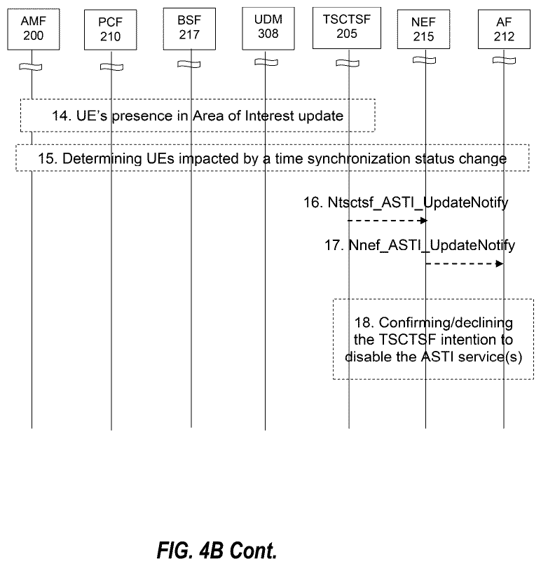

FIG. 4A and FIG. 4B illustrates procedures for management of 5G access stratum time distribution in accordance with some embodiments of the present disclosure. FIG. 4A illustrates the procedure when the TSCTSF 205 performs the compliance check (option 1) and FIG. 4B illustrates the procedure where the AMF performs the compliance check (option 2). The two different Options are brought forward on which core network functions can be used to perform a comparison and actions these NF may perform depending on the outcome of the comparison:
Option 1: TSCTSF 205 is an NF that retrieves “Access and Mobility Subscription data” or other suitable subscription data containing “(Subscribed) Clock Quality Reporting Control Information” from UDM 308 using Nudm_SDM_Get request and compares this information with the one AF 212 requested for an ASTI service via Nnef/tsctsf_ASTI_Create/Update.

This comparison ensures that the AF request service parameters that are compliant with UE's subscription to detect cases when, for example, the AF 212 requests the Clock Quality Detail Level to be “Clock Quality Metrics” whereas the UE's subscription has “Acceptable/Not Acceptable” indication, or the acceptable clock accuracy requested by the AF 212 is more accurate than the acceptable clock accuracy specified in the UE's subscription, etc. Based on the comparison's outcome (a so-called compliance check), the TSCTSF 205 may reject the AF request (Outcome A in FIG. 4A) or override the AF requested “Clock Quality Reporting Control Information” (Outcome B in FIG. 4A) and proceed with the ASTI service activation/modification. The process in shown in FIG. 4A which uses FIG. 4.15.9.4-1 from TS 23.502 v18.0.0 as a baseline.
Option 2: TSCTSF 205 sends the AF-requested “Clock Quality Reporting Control Information” to AMF 200 via PCF 210 as a part of the AM Policy Association Modification procedure. The AMF performs the compliance check and either rejects the request (Outcome A) or overrides the Clock Quality Reporting Control Information (Outcome B in FIG. 4B)

Both figures illustrate the procedure executed in a 5G system as an example system. However not limited thereto. The following describes the detailed steps as illustrated in FIGS. 4A and 4B, the differences are only indicated in the relevant steps and are also apparent in the figures:
Step 1: The AM Policy Association is established between the AMF 200 and a PCF 210 as described in clause 4.16.1 of 4GPP TS 23.502 v. 18.0.0.
Step 2: The procedure is triggered by the AF request to influence the 5G access stratum time distribution. The AF 212 uses the Nnef_ASTI_Create service operation (or Nnef_ASTI_Update service operation) to send a request to the NEF 215. The request comprises Clock Quality Reporting Control Information that includes Clock Quality Detail level and/or Clock Quality Acceptance Criteria as described above. Other parameters may be included as described in 3GPP TS 23.502, clause 5.15.9.4. The AF 212 indicates a target (one UE identified by GPSI or a group of UEs identified by an External Group Identifier) for which the request applies. The NEF 215 forwards the GPSI or the External Group Identifier to the TSCTSF 205 by including it inside the Ntsctsf_ASTI_Create request (step 3).

The AF 212 that is part of operator's trust domain may invoke the services directly with the TSCTSF 205 and identifies the targeted UE(s) using SUPI(s) or an Internal Group Identifier.

Steps 1 and 2 can occur in any order. FIG. 4A and FIG. 4B illustrates the scenario where the AF 212 is not trusted, hence a NEF 215 must be used.
Step 3. After successful authorization of the request by the NEF 215, the NEF 215 invokes the Ntsctsf_ASTI_Create/Update/Delete/Get service operation with the TSCTSF 205 discovered and selected as described in clause 6.3.24 of TS 23.501 v. 18.0.0. The NEF 215 provides to the TSCTSF 205 the information received from the AF. The TSCTSF 205 determines whether the targeted UE is part of a PTP instance in 5GS and calculates the Uu time synchronization error budget.
Step 4. If the AF 212 targeted UE(s) are identified by GPSI(s) or an External/Internal Group Identifier, the TSCTSF 205 uses the Nudm_SDM_Get request to retrieve the subscription information (SUPI(s)) from the UDM 308 using each GPSI or the External Group Identifier as received from the NEF 215, or an Internal Group Identifier as provided by the AF 212 directly. When the TSCTSF 205 is the NF that performs the Clock Quality Reporting Control Information compliance check (FIG. 4A), the TSCTSF 205 may explicitly requests for the subscribed Clock Quality Reporting Control Information from the UDM 308. Alternatively, the UDM 308 may provide the subscription data including the subscribed Clock Quality Reporting Information by default to the TSCTSF.
Step 5. The UDM 308 provides the Nudm_SDM_Get response containing SUPI(s) that are mapped from each received GPSI or the External/Internal Group Identifier and identify the targeted UEs. Step 5 in FIG. 4A illustrates option 1, where TSCTSF 205 performs compliance check (note that this step may occur at step 6c as well. The UDM 308 may also provide subscribed Clock Quality Reporting Control Information as part of the subscription data. If the TSCTSF 205 obtains subscribed Clock Quality Reporting Control Information and (optionally) configured to perform the Clock Quality Reporting Control Information compliance check, the TSCTSF 205 performs the compliance check as described in the Clock Quality Reporting Control Information compliance check procedure below. If TSCTSF 205 performs the compliance check and determines the request from the AF 212 is compliant, it proceeds with the next step (step 6) and includes the AF-provided Clock Quality Reporting Control Information or the subscribed Clock Quality Reporting Control Information. If the compliance check fails, the TSCTSF 205 indicates to the AF 212 (via the NEF 215) that the request is rejected with an optional indication of the cause for rejection, e.g., non-compliance to the subscription and the procedure stops here. Alternatively, the TSCTSF 205 may, instead of rejecting the request for non-compliance, overrides the AF requested Clock Quality Reporting Control Information with the subscribed Clock Quality Reporting Control Information and sends that information to the PCF 210 (see step 8). If the TSCTSF 205 does not perform the compliance check (e.g., is not configured or does not obtain the subscription data for Clock Quality Reporting Control Information) the TSCTSF 205 forwards the AF requested Clock Quality Reporting Control information to the AMF(s) (via PCF(s)), it may also include an (implicit or explicit) indication that the information is requested from the AF 212 (either a flag indicating compliance check not done, or the information is indicated as AF 212 requested) or the like.
Step 6a. If the Ntsctsf_ASTI_Create request in step 2 contains a spatial validity condition, then the TSCTSF 205 performs the operation as in Step 6a in clause 4.15.9.4 of 3GPP TS 23.502 v.18.0.0.
Step 6b. If for any targeted UE, the “AF request Authorization” in the Time Synchronization Subscription Data indicates that the AF 212 is allowed to request 5G access stratum-based time distribution, the TSCTSF 205 proceeds with ASTI service configuration. Otherwise, if the AF 212 is not authorized, steps 7-11 are skipped for this UE.
Step 6c. Note that the compliance check procedure (see step 5 above) may also occur at step 6 after the TSCTSF 205 determines it can proceed with ASTI service configuration but before initiating the configuration.
Step 7. The TSCTSF 205 searches the PCF 210 for the UE using Nbsf_Management_Subscribe with a SUPI as an input parameter, indicating that it is searching for the PCF 210 that handles the AM Policy Association of the UE.
Step 8. The BSF 217 provides to the TSCTSF 205 the identity of the PCF 210 for the UE for the requested SUPI via an Nbsf_Management_Notify operation. If matching entries already existed in the BSF 217 when step 6 is performed, this shall be immediately reported to the TSCTSF.
Step 9. The TSCTSF 205 sends to the PCF 210 for the UE its request for the AM policy of the UE (identified by SUPI) using Npcf_AMPolicyAuthorization request. If the TSCTSF 205 has received from the AF 212 the Clock Quality Reporting Control Information and the TSCTSF 205 has not performed the compliance check procedure, the TSCTSF 205 sends to the PCF 210 the AF requested Clock Quality Reporting Control Information (FIG. 4B). If the TSCTSF 205 performed the compliance check procedure (FIG. 4A), the TSCTSF 205 may include the subscribed Clock Quality Reporting Control Information it obtained from the UDM 308, if AF requested Clock Quality Reporting Control Information is overridden by the subscribed Clock Quality Reporting Control Information (as a result of failed compliance check) or may include the AF requested Clock Quality Reporting Control Information, if the compliance check has passed, i.e., successful. The TSCTSF 205 may also indicate a compliance check status, but the check status is not necessary if the TSCTSF 205 can clearly indicate to the PCF 210 that the Clock Quality Reporting Control Information are AF requested or subscription based. The TSCTSF 205 may also include the 5G access stratum time distribution indication (enable, disable) and optionally the calculated Uu time synchronization error budget as per existing 3GPP procedure (clause 4.15.9.4 of TS 23.502).
Step 10. The PCF 210 takes a policy decision and may initiate an AM Policy Association Modification procedure for the UE as described in clause 4.16.2.2 of 3GPP TS 23.502 to provide to the AMF the 5G access stratum time distribution parameters, the AF requested Clock Quality Reporting Control Information or the subscribed Clock Quality Reporting Control Information whichever is provided by the TSCTSF 205 at step 8. If the AMF receives the AF requested Clock Quality Reporting Control Information, the AMF, as illustrated in FIG. 4B, uses the subscription data previously obtained from the UDM 308 for the UE or group of UE (part of for example Access and Mobility Subscription data) to perform the Clock Quality Reporting Control Information compliance check procedure. The reminder description of this step is in accordance to FIG. 4B until stated otherwise. If the compliance check fails, the AMF may either send to the PCF 210 a reject for the Npcf_AMPolicyAuthorization request, which informs the TSCTSF 205 and which further inform the AF 212 that the ASTI request is rejected. An indication of the rejection may be included by the AMF to indicate non-compliance to the subscription, at which point, the procedure stops here and the subsequent steps are not performed. Alternatively, the AMF may, instead of rejecting the request for non-compliance, overrides the AF requested Clock Quality Reporting Control Information with the UE subscribed Clock Quality Reporting Control Information based on the subscription data stored in the AMF (previously obtained from the UDM 308 during the UE registration) and sends that information to the NG-RAN (see below).

If the compliance check has passed, the AMF 200 should store the PCF 210 received information including the AF-provided (or subscribed) Clock Quality Reporting Control Information, the subscribed Clock Quality Reporting Control Information, 5G access stratum time distribution indication (enable, disable) and the Uu time synchronization error budget in the UE context and send them to NG-RAN immediately or during mobility registration, AM policy modification, Service Request, N2 Handover and Xn handover as specified in 3GPP TS 38.413. Either the AF-requested or subscribed Clock Quality Reporting Control Information should be included to the NG-RAN depending on the compliance check procedure. The NG-RAN node shall, if supported, store the information in the UE Context. Based on this information, the NG-RAN node provides the 5GS access stratum time to the UE according to the Uu time synchronization error budget as provided by the TSCTSF 205 (if supported by UE and NG-RAN).

If the AMF 200 receives from the PCF 210 the subscribed Clock Quality Reporting Control Information, as in FIG. 4A, (the option where the AF-requested Clock Quality Control Information was overwritten by the TSCTSF), the AMF does not need to execute the performance compliance check, albeit it may check the received information against its subscription data to determine if they match. (This extra check is however not necessary if the AMF knows it is receiving the subscribed Clock Quality Reporting Control Information from the PCF). The AMF then provides the subscribed Clock Quality Reporting Control information to the NG-RAN.
Step 11. The PCF 210 of the UE replies to the TSCTSF 205 with the result of Npcf_AMPolicyAuthorization operation.
Step 12. The TSCTSF 205 responds to the AF 212 with the Ntsctsf_ASTI_Create/Update/Delete/Get service operation response.
Step 13. The NEF 215 informs the AF 212 about the result of the Nnef_ASTI_Create/Update/Delete/Get service operation performed in step 2.
Step 14. If TSCTSF 205 received spatial validity condition as part of the Ntsctsf_ASTI_Create request in step 2, upon the reception of a change in the UE presence in Area of Interest notification, the TSCTSF 205 determines if the spatial validity condition shall trigger an activation or deactivation of the access stratum time distribution:
   If the UE has moved inside the spatial validity condition, then the TSCTSF 205 determines to enable access stratum time distribution for the UE.
   If the UE has moved outside the spatial validity condition, then the TSCTSF 205 determines to disable access stratum time distribution for the UE.
Steps 15-18. If TSCTSF 205 determines to modify access stratum time distribution for the UE in step 14 for which the AF requested access stratum time distribution, the TSCTSF 205 notifies the service status to AF.

One or more advantages of performing this compliance check includes besides ensuring that in its request for an ASTI service an AF 212 includes parameters compliant with UE's subscription, the AF 212 can also provide a finer granularity/control for time synchronization status reporting towards UE's.

For example, let's assume a UE has a subscription to receive ASTI-based time synchronization services and get informed about changes in timing synchronization status via reports, and the UE's subscription specifies “Clock Quality Reporting Control Information” that is set to:
(Subscribed) Clock Quality Detail Level=“Acceptable/Not Acceptable” indication and/or
(Subscribed) Clock Quality Acceptance Criteria (shall be provided whenever the Clock Quality Detail Level is set to “Acceptable/Not Acceptable” indication) are specified by combination of three different clock characteristics, for example,
   (acceptable) Synchronization State=“Locked”
   (acceptable) source time=“PTP”
   (acceptable) clock quality descriptor: “ClockAccuracy”=900 ns.

Then, for a particular ASTI service, an AF 212 includes in the request (step 2 of FIG. 4) more relaxed parameters when specifying “AF requested Clock Quality Reporting Control Information”, e.g.:
(AF requested)=“Acceptable/Not Acceptable” indication—complies with the subscription Clock Quality Detail Level;
(AF requested) Clock Quality Acceptance Criteria:
   (acceptable) Synchronization State=“Holdover”
   (acceptable) source time=“PTP”
   (acceptable) clock quality descriptor: “ClockAccuracy”=1100 ns

In this scenario, the UE has a subscription to receive a report (from AMF over the control plane, e.g., RRC signalling from NG-RAN or perhaps Non-Access Stratum signalling) containing the “Acceptable/Not Acceptable” indication whenever the clock quality changes from the “Locked” state or whenever the “ClockAccuracy” drops above 900 ns. However, since the ASTI service requested by the AF 212 for this UE is not that sensitive, the AF 212 determines that there is no need to inform the UE even when the synchronization state moves from “Locked” to “Holdover” (i.e., as long as it is not in “Freerun”) or when ClockAccuracy is better than 1100 ns.

In the same way, the reporting rules can contain several values for “Clock Quality Acceptance Criteria” or their ranges, i.e., in order to specify when a new timing synchronization status reporting shall be triggered can be specified using several values or sets of attributes and their combinations inside the “Clock Quality Acceptance Criteria.” This enables to define conditions (described via the “Clock Quality Acceptance Criteria”) when a new timing synchronization status reporting shall be done towards UE(s) and/or towards an AF requested the affected time synchronization services in more detailed way. This makes such reporting more relevant and tuned towards the actual time synchronization service requirements.

Additionally, if UE's subscription specifies Clock Quality Detail Level=“Clock Quality Metrics”, it should be eligible to receive a less detailed report, i.e., “Acceptable/Not Acceptable” indication, if the AF 212 has requested that for a service.

Furthermore, (AF-Requested Clock Quality Reporting Control Information) can be used to set/adjust thresholds NG-RAN use to perform the initial reporting towards the TSCTSF, which minimizes a number of reports NG-RAN sends TSCTSF 205 via OAM (unless the NG-RAN supports and has the pre-configuration to use the NGAP signalling via AMF for this purpose, which alternatively may be used.

### Clock Quality Reporting Control Information Compliance Check Procedure

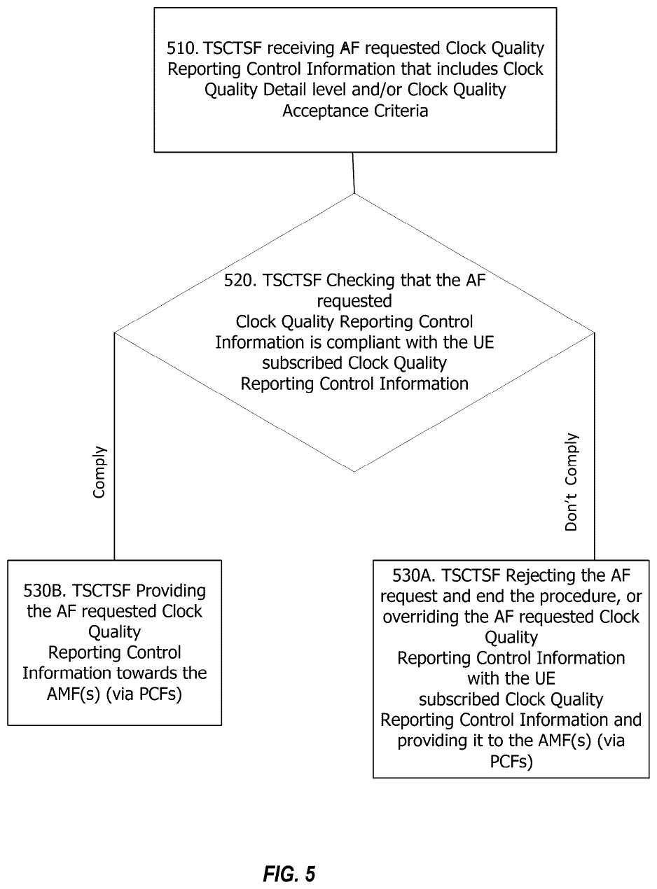

FIG. 5 illustrates Clock Quality Reporting Control Information compliance check procedure when performed by the TSCTSF in accordance with some embodiments.

At step 510, the TSCTSF receives AF requested Clock Quality Reporting Control Information that includes Clock Quality Detail level and/or Clock Quality Acceptance Criteria as described above. The TSCTSF receives the information directly from the AF or via the NEF.

At step 520, It may be that the TSCTSF is configured to perform the compliance check. If configured to perform the compliance check or if configuration is not used, i.e., TSCTSF performs the compliance check by default for every ASTI request from the AF that includes the AF requested Clock Quality Reporting Control Information. The TSCTSF obtains subscription data from the UDM 308 (e.g., Time Synchronization Subscription data) containing subscribed Clock Quality Reporting Control Information. The TSCTSF checks if the AF requested Clock Quality Reporting Control Information comply with the subscription Clock Quality Reporting Control Information. At Step 530A, in the cases where the AF requested Clock Quality Reporting Control Information do not comply with the subscription Clock Quality Reporting Control Information, the TSCTSF may reject the request originated from the AF and end the procedure or may override the AF requested Clock Quality Reporting Control Information with the subscribed Quality Reporting Control Information and provides it to the AMF(s) (via the PCF(s) or potentially directly). At step 530B, in other cases, where there is compliance, the TSCTSF provides the AF requested Clock Quality Reporting Control Information to AMF(s) serving the UE(s). The the AMF(s) provides this information, together with the 5G access stratum time distribution indication and the Uu time synchronization error budget, to NG-RAN nodes as further described in FIG. 4B.

As indicated above the Clock Quality Reporting Control Information comprises:
Clock Quality Detail Level: indicates whether and which clock quality information to provide to the UE and can take one of the following values: Clock Quality Metrics or acceptable/not acceptable indication;
Clock Quality Acceptance Criteria: if the clock quality level equals “acceptable/not acceptable indication”, the clock quality acceptance criteria for the UE (e.g. acceptable clock accuracy, acceptable frequency stability, etc.).”

The following describes some examples of compliance check failure detected at step 520/530A by the TSCTSF: For example, compliance check fails if the AF requested Clock Quality Detail Level indicates “Clock Quality Metrics” whereas the UE's subscription Clock Quality Detail Level indicates “Acceptable/Not Acceptable”. Alternatively, Compliance check may fail if the AF requested Clock Quality Acceptance Criteria indicates an acceptable clock accuracy that is more accurate than the acceptable clock accuracy specified in the UE's subscription Clock Quality Acceptance Criteria, etc.

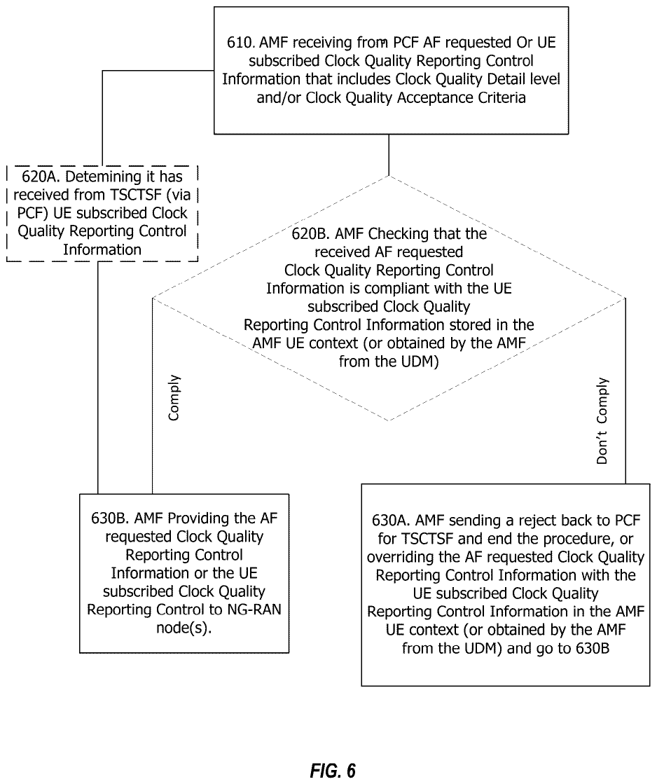

FIG. 6 illustrates Clock Quality Reporting Control Information compliance check procedure when performed by the AMF in accordance with some embodiments. The method is similar to the method performed by TSCTSF with some differences.

At step 610, the AMF receives from the TSCTSF via the PCF for one or more UE (e.g., single UE or group of UE), AF requested Clock Quality Reporting Control Information or subscribed Clock Quality Reporting Control Information (e.g., when overridden by the TSCTSF) that includes Clock Quality Detail level and/or Clock Quality Acceptance Criteria as described above and may also receive 5G access stratum time distribution parameters. The AMF may receive the Clock Quality Reporting Control information and access stratum time distribution parameters via the AM Policy Association Modification procedure.

At step 620A, If the AMF receives the subscribed Clock Quality Reporting Control Information from the TSCTSF (via the PCF), the AMF may (albeit not necessary) check that it is compliant to the subscribed Clock Quality Reporting Control Information that was previously obtained within the (Access and Mobility) Subscription Data as part of the UE registration procedure and stored in the UE context. The AMF uses the subscribed Clock Quality Reporting Control Information for transmission to the NG-RAN.

At step 620B, if the AMF receives the AF requested Clock Quality Reporting Control Information, the AMF checks whether the AF requested Clock Quality Reporting Control Information is compliant with the subscribed Clock Quality Reporting Control Information available/stored in the UE context of the AMF (part of the Access and Mobility subscription data received during the UE registration procedure). In the cases where the AF requested Clock Quality Reporting Control Information do not comply with the subscribed Clock Quality Reporting Control Information, the AMF may at step 630A reject the request from the TSCTSF (via the PCF) and end the procedure or the AMF may override the AF requested Clock Quality Reporting Control Information with the subscribed Quality Reporting Control Information from the subscription data. At step 620B, if the AF requested Clock Quality Reporting Control Information is compliant to the subscribed Clock Quality Reporting Control Information, the AMF stores the AF requested Clock Quality Reporting Control Information and goes to step 630B. The AMF should respond to the PCF to indicate the result of the compliance check, which informs the TSCTSF.

At step 630B, the AMF provides either the AF requested (e.g., when compliance is successful) or the subscribed Clock Quality Reporting Control Information (e.g., when the AF requested Clock Quality Reporting Control Information is overridden by either the AMF or TSCTSF), together with the 5G access stratum time distribution indication and the Uu time synchronization error budget to NG-RAN nodes over a suitable N2 signalling (NGAP signalling) message. An NG-RAN node uses this Clock Quality Reporting Control Information to identify and set up parameter thresholds whose excess triggers a timing synchronization status report to be sent towards the TSCTSF. NG-RAN may send a time synchronization status report to TSCTSF via OAM, unless the NG-RAN supports and has the preconfiguration to use the N2/NGAP signalling via AMF for this purpose. Based on the received timing synchronization status report from NG-RAN, the TSCTSF determines a list of UEs to whom a timing synchronization status report shall be sent. The TSCTSF sends the determined list of affected UEs and the current timing synchronization status report to AMF(s). The AMF(s) transfer the report to NG-RAN nodes in the N2/NGAP signalling, and then the NG-RAN sends the report to UEs in RRC_CONNECTED state using a dedicated RRC signalling.

A timing synchronization status report contains either:
a predefined set of Clock Quality Metrics (e.g., synchronization state, source type, clock quality descriptor) that reflects an NG-RAN node's current timing synchronization status if the Clock Quality Detail Level in the UE's subscription is set to “Clock Quality Metrics”, or
an “Acceptable/Not Acceptable” indication depending on whether the NG-RAN node's timing synchronization status matches the acceptance criteria or not.

Going back to step 620, as indicated above, the Clock Quality Reporting Control Information comprises:
Clock Quality Detail Level which indicates whether and which clock quality information to provide to the UE and can take one of the following values: Clock Quality Metrics or acceptable/not acceptable indication;
Clock Quality Acceptance Criteria: if the clock quality level includes “acceptable/not acceptable indication”, the clock quality acceptance criteria for the UE (e.g. acceptable clock accuracy, acceptable frequency stability, etc.).”

The following describes some examples of compliance check failure performed at step 620: For example, compliance check fails if the AF requested Clock Quality Detail Level indicates “Clock Quality Metrics” whereas the UE's subscription Clock Quality Detail Level indicates “Acceptable/Not Acceptable”. Alternatively, Compliance check may fail if the AF requested Clock Quality Acceptance Criteria indicates an acceptable clock accuracy that is more accurate than the acceptable clock accuracy specified in the UE's subscription Clock Quality Acceptance Criteria, etc.

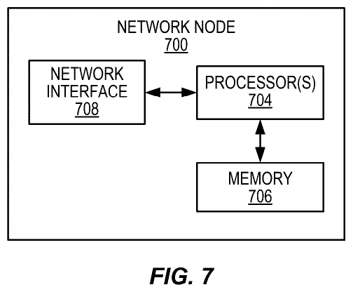

FIG. 7 is a schematic block diagram of a network node 700 according to some embodiments of the present disclosure. Optional features are represented by dashed boxes. The network node 700 may be, for example, a core network node that implements a NF (e.g., AMF 200, SMF 208, UDM 308, TSCTSF, AF, PCF) or a network node that implements all or part of the functionality of an NF (e.g., all or part of the functionality of the AMF 200, SMF 208, UDM 308, TSCTSF 205, AF 212, PCF 210 described herein). As illustrated, the network node 700 includes a one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. The one or more processors 704 operate to provide one or more functions of the network node 700 as described herein (e.g., one or more functions of the AMF 200, SMF 208, UDM 308, TSCTSF 205, AF 212, PCF 210 described herein). In some embodiments, the function(s) are implemented in software that is stored, e.g., in the memory 706 and executed by the one or more processors 704.

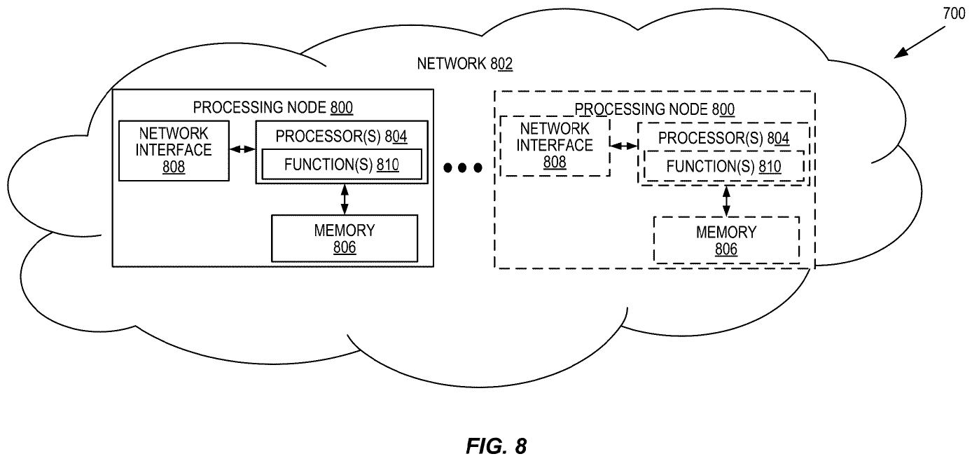

FIG. 8 is a schematic block diagram that illustrates a virtualized embodiment of the network node 700 according to some embodiments of the present disclosure. Again, optional features are represented by dashed boxes. As used herein, a “virtualized” network node is an implementation of the network node 700 in which at least a portion of the functionality of the network node 700 is implemented as a virtual component(s) (e.g., via a virtual machine(s) executing on a physical processing node(s) in a network(s)). As illustrated, in this example, the network node 700 includes one or more processing nodes 800 coupled to or included as part of a network(s) 802. Each processing node 800 includes one or more processors 804 (e.g., CPUs, ASICs, FPGAs, and/or the like), memory 806, and a network interface 808. In this example, functions 810 of the network node 700 described herein (e.g., one or more functions of the AMF 200, SMF 208, UDM 308, TSCTSF 205, AF 212, PCF 210 described herein) are implemented at the one or more processing nodes 800 or distributed across the two or more processing nodes 800 in any desired manner. In some particular embodiments, some or all of the functions 810 of the network node 700 described herein are implemented as virtual components executed by one or more virtual machines implemented in a virtual environment(s) hosted by the processing node(s) 800.

In some embodiments, a computer program including instructions which, when executed by at least one processor, causes the at least one processor to carry out the functionality of the network node 700 or a node (e.g., a processing node 800) implementing one or more of the functions 810 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

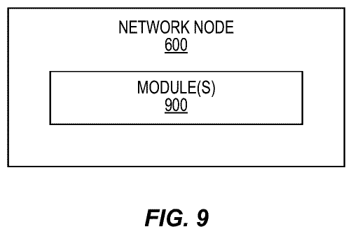

FIG. 9 is a schematic block diagram of the network node 700 according to some other embodiments of the present disclosure. The network node 700 includes one or more modules 900, each of which is implemented in software. The module(s) 900 provide the functionality of the network node 700 described herein. This discussion is equally applicable to the processing node 800 of FIG. 8 where the modules 800 may be implemented at one of the processing nodes 800 or distributed across multiple processing nodes 800.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

The following are example non-limiting claim embodiments to be used as a basis for future claims. However, the complete content of this application will be used as a basis for future claims.

### Group A: TSCTSF

Embodiment 1. A method for managing access stratum time information service in a system, the method comprising:
receiving an Application Function (AF) request to influence a system access stratum time distribution for at least one User Equipment (UE) comprising AF requested Clock Quality Reporting Control Information (AF requested CQRCI);
in response to determining the AF requested CQRCI is not compliant to obtained UE subscribed CQRCI for the at least one UE, performing one of:
   rejecting the AF request or
   overriding the AF requested CQRCI with the UE subscribed CQRCI and sending the UE subscribed CQRCI towards one or more AMFs (via PCFs),
in response to determining the AF requested CQRCI is compliant to the obtained UE subscribed CQRCI, sending the AF requested CQRCI for the at least one UE towards one or more AMFs (via PCFs).

Embodiment 2. The method of embodiment 1 wherein the method further comprises obtaining subscription data comprising UE subscribed CQRCI for the at least one UE.

Embodiment 3. The method of any one of embodiment 1-2, wherein the at least one UE corresponds to one UE or a group of UE.

Embodiment 4. The method of embodiment 1 where in the AF request is received from an Application Function or from a Network Exposure Function.

Embodiment 5. The method of any one of embodiments 1-4 wherein the system is a 5G system.

Embodiment 6. The method of embodiment 1 wherein the AF requested Clock Quality Reporting Control Information or the UE subscribed CQRCI comprises Clock Quality Detail Level.

Embodiment 7. The method of embodiment 1 wherein the AF requested Clock Quality Reporting Control Information or the UE subscribed CQRCI comprises Clock Quality Detail Level and Clock Quality Acceptance Criteria.

### Group B: AMF

Embodiment 8. A method for managing access stratum time information service in a system, the method being performed by an Access and Mobility Management function connected to one or more access nodes, the method comprising:
receiving from a policy control function Application Function (AF) requested Clock Quality Reporting Control Information (CQRCI) for at least one User Equipment (UE);
in response to determining the AF requested CQRCI is not compliant to AMF stored subscription data for the at least one UE, performing one of:
   indicating a rejection to the PCF, or
   overriding the AF requested CQRCI with a second CQRCI based on the AMF stored subscription data and sending the second CQRCI to the one or more access nodes;
in response to determining the AF requested CQRCI is compliant to the AMF stored subscription data for the at least one UE, sending the AF requested CQRCI for the at least one UE to the one or more access nodes.

Embodiment 9. The method of embodiment 8 wherein the AMF stored subscription data for the at least one UE corresponds to the Access and mobility management data comprising the second CQRCI and obtained from a User Data Management function.

Embodiment 10. The method of any one of embodiments 8-9, wherein the at least one UE corresponds to one UE or a group of UE.

Embodiment 11. The method of any one of embodiments 8-10 wherein the system is a 5G system.

Embodiment 12. The method of embodiment 11 wherein the access node is a NG-RAN node.

Embodiment 13. The method of embodiment 8 wherein the Clock Quality Reporting Control Information comprises Clock Quality Detail Level.

Embodiment 14. The method of embodiment 8 wherein the Clock Quality Reporting Control Information comprises Clock Quality Detail Level and Clock Quality Acceptance Criteria.

### Group C: AMF

Embodiment 15. A method for managing access stratum time information service in a system, the method being performed by an Access and Mobility Management function connected to one or more access nodes, the method comprising:
receiving from a policy control function subscribed Clock Quality Reporting Control Information (CQRCI) for at least one User Equipment (UE);
sending subscribed CQRCI to the one or more access nodes.

Embodiment 16. The method of embodiment 15 further comprising prior to sending subscribed CQRCI to the one or more access nodes,
checking the received subscribed CQRCI from the policy control function corresponds to AMF stored subscription data for the at least one UE,
in response to determining the received subscribed CQRCI does not correspond to the AMF stored subscription data performing one of:
   indicating a rejection to the PCF, or
   overriding the received subscribed CQRCI with subscribed CQRCI based on the AMF stored subscription data.

Embodiment 17. The method of any one of embodiments 15-16, wherein the at least one UE corresponds to one UE or a group of UE.

Embodiment 18. The method of any one of embodiments 15-16 wherein the system is a 5G system.

Embodiment 19. A network node adapted to perform the method of any of embodiments 1 to 18.

Embodiment 20. A non-transitory computer-readable storage medium that includes executable instructions that when executed by a processor cause the processor to perform the method of any of embodiments 1 to 18.

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Management Function
AN Access Network
ASIC Application Specific Integrated Circuit
ASTI Access Stratum based Time Distribution service
AUSF Authentication Server Function
CPU Central Processing Unit
DN Data Network
DSP Digital Signal Processor
eNB Enhanced or Evolved Node B
FPGA Field Programmable Gate Array
gNB New Radio Base Station
IP Internet Protocol
LTE Long Term Evolution
NEF Network Exposure Function
NF Network Function
NR New Radio
NRF Network Function Repository Function
OTT Over-the-Top
PC Personal Computer
PCF Policy Control Function
PDU Packet Data Session Unit
PTP Precision Time Protocol
RAM Random Access Memory
RAN Radio Access Network
ROM Read Only Memory
RP Reception Point
RRH Remote Radio Head
RTT Round Trip Time
SMF Session Management Function
TSCTSF Time Sensitive Communication and Time Synchronization Function
UDM Unified Data Management
UE User Equipment
UPF User Plane Function
VPLMN Visited Public Land Mobile Network

### APPENDIX A

The following describes additional 3GPP material including additional embodiments that are based on the embodiments described in this disclosure. The subject matter of this material is not limiting and can be used to derive future claims:

| | |
|---|---|
| Reason for change: | In clause 8.5 of TR 23.700-25, it has been agreed on detection NG- |
| | RAN/UPF timing synchronization degradations/failures/improvement |
| | events, determination of the umpacted UEs and the ongoing time sync |
| | services, and reporting changes time sync status to AFs and UEs. |
| Summary of change: | Introducing a new clause (5.27.1.X) to TS 23.501 describing how a timing |
| | synchronization status change shall be determined and reported to AFs and |
| | UEs with the corresponding subscription. |
| Consequences if not | The agreed new feature is not supported. |
| approved: | |

### >>>>Start of Changes<<<<

5.27.1.X Reporting timing synchronization status
5.27.1.X.1 RRC_CONNECTED state

In order to obtain information about 5GS network timing synchronization status, TSCTSF subscribes to NG-RAN and/or UPF (if the UPF/NW-TT is involved in providing timing information to a UE/DS-TT and only for (g)PTP time distribution method) timing synchronization status information, when the feature is active. When configured, both the NG-RAN and the UPF can detect timing synchronization degradations/failures/improvements locally. In the case of UPF timing synchronization status, the detection is based on the information provided by transport network time synchronization protocols and, in case of the NG-RAN timing synchronization status, the detection is based on the information from a local GNSS receiver.
NOTE 1: The details on how NG-RAN/UPF detects timing synchronization degradation/failure/improvement locally are implementation specific.

Depending on whether NG-RAN or UPF provides the information, TSCTSF retrieves the information about the timing synchronization as follows:
provided via OAM to TSCTSF from NG-RAN and/or UPF;
control plane signalling where UMIC may be used to inform TSCTSF about a UPF's timing synchronization status or
via NGAP node-level signalling for NG-RAN timing synchronization status reporting towards TSCTSF (via AMF).

The TSCTSF retrieved information from a NG-RAN/UPF is at a node-level; and it can contain, synchronization state (“Locked”, “Holdover”, “Freerun”) [optional], source type (e.g, “PTP”, “GNSS”, “other”) [optional], clock quality descriptor (e.g., “clockClass”, “ClockAccuracy”, “gnss-rx-time-error”) [mandatory]. Once the information about the NG-RAN and/or the UPF timing synchronization status is obtained, the TSCTSF determines whether any UE with an ongoing time synchronization service is impacted by a timing synchronization degradation/failure/improvement event.
To determine UEs impacted by a NG-RAN timing synchronization degradation/failure/improvement, the TSCTSF correlates the information about NG-RAN nodes impacted by a timing synchronization status changes and UE's Presence in Area of Interest for UEs for which AF has requested a time synchronization service or for which a (g)PTP-based time synchronization service has been activated based on the subscription. When subscribing to UE's Presence in Area of Interest from an AMF serving the UE(s), the TSCTSF specifies the Area of Interest by a list of RAN node IDs that have the same NG-RAN timing synchronization status.
To determine UEs impacted by a UPF timing synchronization degradation/failure/improvement (only for cases where a UPF/NW-TT is involved in providing timing information to a DS-TT), the TSCTSF identifies UEs for which the impacted UPF/NW-TT is configured to send (g)PTP messages.

If an AF is a requester of a (g)PTP or ASTI-based time synchronization service, the AF may subscribe to the TSCTSF to get informed about the timing synchronization status change for those UEs or a group of UEs with the corresponding subscription for time synchronization services and impacted by NG-RAN or UPF timing synchronization degradations/failures/improvements. Together with a notification about a timing synchronization status, the TSCTSF may indicate to the AF whether the ongoing (g)PTP or ASTI-based time synchronization service can/cannot be supported as per the requested criteria (e.g., a time synchronization error budget) and may inquire the AF about intentions to deactivate the service (see clauses 4.15.9.3 and 4.15.9.4 in TS 23.502 [3]).

UEs with the corresponding subscription also may get informed about the timing synchronization status change. However, to ensure the backward compatibility with Rel-17 UEs, time synchronization status report can be sent to a UE only when the UE has a corresponding subscription, and the subscription data contains “Clock Quality Reporting Control Information”.

Level of information about an NG-RAN timing synchronization degradations/failures/improvements reported to a UE is set by Clock Quality Reporting Control Information that includes:
Clock Quality Detail Level: it indicates whether and which clock quality information shall be provided to the UE, and it can be set to “Clock Quality Metrics” or to “Acceptable/Not Acceptable” indication;
Clock Quality Acceptance Criteria: it shall be specified if the Clock Quality Detail Level for the UE is set to “Acceptable/Not Acceptable” indication and then parameters constituting the clock quality acceptance criteria for the UE shall be in provided. These parameters can be, for example, acceptable synchronization state, acceptable clock quality descriptor, etc.
NOTE 2: Whether and which clock quality information to provide to the UE depends on the needs of the time service consumer (referred to as client network operator hereafter). Therefore, the clock quality detail level and clock quality acceptance criteria are based on the parameters and their values specified in the agreement between the 5G network operator and the client network operator. The clock quality acceptance criteria consider propogation delays while UE capabilities and internal inaccurancies are assumed to be budgeted by the client network operator when agreeing the required clock accuracy with the 5G network operator.

The Clock Quality Reporting Control Information may be a part of “Access and Mobility Subscription data” stored in a UDM (see clause 5.27.1.11) to specify a UE's subscription for Access Stratum Time Synchronization (ASTI) services.

An AF requesting an ASTI service also may include Clock Quality Reporting Control Information in its request; and this Clock Quality Reporting Control Information shall comply with the UE's subscription, which shall be checked by the TSCTSF. In cases when an AF requests the Clock Quality Reporting Control Information that does not comply with the UE's subscription (e.g., the AF request the Clock Quality Detail Level to be “Clock Quality Metrics” whereas the UE's subscription has “Acceptable/Not Acceptable” indication, or the acceptable clock accuracy requested by the AF is more accurate than the acceptable clock accuracy specified in the UE's subscription, etc.), the AF request shall be rejected. In other cases, the TSCTSF provides the Clock Quality Reporting Control Information (included in the AF request or obtained from the UE's subscription) to AMF(s) serving the UE(s); and the AMF(s) provides this information, together with the 5G access stratum time distribution indication and the Uu time synchronization error budget, to NG-RAN nodes as described in clause 4.15.9.4 of TS 23.502 [3].

An NG-RAN node uses this Clock Quality Reporting Control Information to identify and set up parameter thresholds whose excess triggers a timing synchronization status report to be sent towards the TSCTSF. NG-RAN sends a time synchronization status report to TSCTSF via OAM, unless the NG-RAN supports and has the preconfiguration to use the NGAP signalling via AMF for this purpose, which alternatively may be used. Based on the received timing synchronization status report from NG-RAN, the TSCTSF determines a list of UEs to whom a timing synchronization status report shall be sent. The TSCTSF sends the determined list of affected UEs and the current timing synchronization status report to AMF(s). The AMF(s) transfer the report to NG-RAN nodes in the NGAP signalling, and then the NG-RAN sends the report to UEs in RRC_CONNECTED state using a dedicated RRC signalling.
Editor's Note: Details on how a timing synchronization status report is sent to UEs in the RRC_CONNECTED state via dedicated RRC signalling are up to RAN WG2.

A timing synchronization status report contains either:
a predefined set of Clock Quality Metrics (e.g., synchronization state, source type, clock quality descriptor) that reflects an NG-RAN node's current timing synchronization status if the Clock Quality Detail Level in the UE's subscription is set to “Clock Quality Metrics”, or
an “Acceptable/Not Acceptable” indication depending on whether the NG-RAN node's timing synchronization status matches the acceptance criteria or not.

1. A computer-implemented method performed by a first network function in a communication system, the method comprising:
receiving a message from a second network function comprising requested Clock Quality Reporting Control Information (CQRCI) for at least one UE;
in response to determining the CQRCI is not compliant to obtained UE subscribed CQRCI for the at least one UE, overriding the CQRCI with the UE subscribed CQRCI and sending the UE subscribed CQRCI directly or indirectly to a third network function serving the UE.

2. The computer-implemented method of claim 1, further comprising in response to determining the received CQRCI is compliant to the obtained UE subscribed CQRCI, sending the received CQRCI for the at least one UE directly or indirectly to the third network function serving the UE.

3. The computer-implemented method of claim 1, further comprising in response to determining the received CQRCI is not compliant to the obtained UE subscribed CQRCI, sending a rejection message to the second network function.

4. The computer-implemented method of claim 1, wherein the method further comprises obtaining subscription data from a subscription management function, the subscription data comprising the UE subscribed CQRCI for the at least one UE.

5. The computer-implemented method of claim 1, wherein the at least one UE corresponds to one UE or a group of UE.

6. The computer-implemented method of claim 1, wherein the communication system is a 5G system or a 6G system.

7. The computer-implemented method of claim 6, wherein the first network function is a Time Sensitive Communication and Time Synchronization Function (TSCTSF) or an Access and Mobility Management Function (AMF).

8. The computer-implemented method of claim 6, wherein the second network function is one of a Network Exposure Function (NEF) or Application Function (AF) when the first network function is the TSCTSF or the second network function is a Policy Control Function (PCF) when the first network function is the AMF.

9. The computer-implemented method of claim 1, wherein the third network function is an Access and Mobility Management Function (AMF) when the first network function is a TSCTSF or wherein the third network function is an access node when the first network function is an AMF.

10. The computer-implemented method of claim 9, wherein the access node is a NG-RAN node.

11. The computer-implemented method of claim 1, wherein when the first network function is the AMF, the message corresponds to a modification to a previously established Access & Mobility (AM) policy association with the second network function.

12. The computer-implemented method of claim 1, wherein the received Clock Quality Reporting Control Information or the UE subscribed CQRCI correspond to Clock Quality Detail Level and Clock Quality Acceptance Criteria.

13. The computer-implemented method of claim 1, wherein the received Clock Quality Reporting Control Information or the UE subscribed CQRCI correspond to Clock Quality Acceptance Criteria.

14. A network node implementing a first network function adapted to perform:
receiving a message from a second network function comprising requested Clock Quality Reporting Control Information (CQRCI) for at least one UE;
in response to determining the CQRCI is not compliant to obtained UE subscribed CQRCI for the at least one UE, overriding the CQRCI with the UE subscribed CQRCI and sending the UE subscribed CQRCI directly or indirectly to a third network function serving the UE.

15. A non-transitory computer-readable storage medium that includes executable instructions that when executed by a processor cause the processor to perform:
receiving a message from a first network function comprising requested Clock Quality Reporting Control Information (CQRCI) for at least one UE;
in response to determining the CQRCI is not compliant to obtained UE subscribed CQRCI for the at least one UE, overriding the CQRCI with the UE subscribed CQRCI and sending the UE subscribed CQRCI directly or indirectly to a second network function serving the UE.

16. (canceled)
